(19) United States
(12) Patent Application Publication
(10) Pub. No.: US 2001/0023474 A1
(43) Pub. Date: Sep. 20, 2001

(54) Array storage device and information processing system

(75) Inventors: Shinya Kyozuka, Nakai-machi (JP); Tsutomu Hamada, Nakai-machi (JP); Takeshi Kamimura, Nakai-machi (JP); Masao Funada, Nakai-machi (JP)

Correspondence Address: Oliff & Berridge PLC, P.O. Box 19928, Alexandria, VA, 22320, US

(73) Assignee: FUJI XEROX CO., LTD

(21) Appl. No.: 09/726,442

(22) Filed: Dec. 1, 2000

(30) Foreign Application Priority Data
Mar. 16, 2000 (JP) JP 2000-074807

(51) Int. Cl. G06F 12/00

(52) U.S. Cl. 711/114

(57) ABSTRACT

The present invention suppresses a data writing speed in mirroring and increases expandability. For a write request from a host, a disk controller stores write data in cache memory, and then transforms it into optical signals by a light emitting apparatus and sends them to an optical bus. The signal light inputted to the optical bus is broadcast-transmitted by the optical bus and read into disk drives simultaneously through a light receiving apparatus. This suppresses reduction in a data writing speed in mirroring and increases expandability.

### BACKGROUND OF THE INVENTION

1. Field of the Invention

The present invention relates to an array storage device used as a secondary storage device in a computer system and the like, and more particularly to an array storage device that stores data in multiplexed form, and an information processing system that uses the array storage device.

2. Description of the Prior Art

Secondary storage devices of a computer system, in which nonvolatile storage media are generally used, typically include magnetic disk units and optical disk units. Recently, there are demands for high performance for these types of secondary storage devices, such as higher data transfer speed and reliability. As one method for meeting these demands, an array storage device including a large number of secondary storage devices (hereinafter referred to as disk drives) is used.

RAID (Redundant Arrays of Independent Disks) is known as configurations of array storage deices. RAID configurations include: RAID0 in which data is split in sectors or bytes (striping) to transfer the data; RAID1 in which mirroring is performed by writing exactly the same data to plural disk drives; RAID3 and RAID4 in which parity data is generated from data subjected to striping, and the data and parity data are stored in dedicated disk drives; and RAID5 in which data and parity data are spread across plural disk drives to store them. Other configurations of RAID are RAID1+3, RAID1+4, and RAID1+5 which combine mirroring and parity data. A known literature on RAID is, e.g., “The RAID Book: A STORAGE SYSTEM TECHNOLOGY HANDBOOK” The RAID Advisory Board, 1997.

Hereinafter, a brief description will be made of RAID. In RAID1 configured with one disk array controller and two disk drives, for a data write request from a superior apparatus (host), write data is stored in a cache memory, and then the same data is written to the two disk drives. For a data read request from the host, the disk array controller returns, if request data exists in the cache memory, the request data to the host. When it does not exist in the cache memory, the disk array controller accesses one of the two disk drives to read data, returns it to the host, and stores it in the cache memory. If a failure occurs in one of the disk drives, the disk array controller accesses another disk drive to read data. In this way, data loss due to a disk drive failure can be prevented.

The number of disk drives used for mirroring is not limited to two; if mirroring is performed for three or more disk drives, data loss due to double failures (concurrent failures in two disk drives) in the disk drives can also be prevented.

Although data loss due to a disk drive failure can be prevented by the above-described method, if a failure occurs in a disk array controller, data read and write requests from a host cannot be satisfied. To solve this problem, an array storage device having higher reliability is proposed in which, with plural disk array controllers provided, in normal times, one disk array controller controls data exchange with a host and data reading and writing from and to disk drives, and if a failure occurs in the disk array controller, data exchange with the host and disk drives is performed by another disk array controller.

Data transfer between a disk array controller and a disk drive is performed through electric buses such as SCSI (small computer system interface) buses or the like. With electrical buses, in a connection between a disk array controller and disk drives, the number of disk drives that can be accessed simultaneously is only one. FIG. 5 shows a timing chart for a data writing operation during mirroring when one disk array controller and two disk drives are connected through an SCSI bus. The disk array controller establishes a connection with the disk drive A and transfers data to a disk drive A. Upon termination of data transfer to the disk drive A, the disk array controller frees the connection with the disk drive A, establishes a connection with a disk drive B, and transfers the same data transferred to the disk drive A to the disk drive B. When data is thus written, since the same data Do (or data D₁) is sent twice in a time-sharing mode from the disk array controller, a writing speed is reduced to almost one-half that when mirroring is not performed. In a configuration in which mirroring is performed for three or more disk drives to ensure reliability for double failures in the disk drives, there is the problem that a writing speed is further reduced because the number of times identical data is sent increases.

In configuring an array storage device in which plural disk array controllers are provided to provide higher reliability, the plural disk array controllers must be connected to one disk drive, so that wirings corresponding to the number of disk array controllers are required. Therefore, there is also the problem that, when disk array controllers or disk drives are added to an array storage device once configured to expand the system, the interconnections must be reconfigured, reducing system expandability.

### SUMMARY OF THE INVENTION

The present invention has been made to solve the above technical problems and provides an array storage device and an information processing system that can suppress reduction in a data writing speed in mirroring and have high expandability.

An array storage device of the present invention stores information inputted to and outputted from an information processing unit. The array storage device has: plural storage devices in which the information is stored; and a broadcast optical transmission medium which has plural access ports to which the information processing unit and each of the plural storage devices are connected and through which the information is inputted and outputted, and through which the information is transmitted as optical signals.

An information processing system of the present invention has: an information processing unit that inputs and outputs data; plural storage devices in which the data is stored; and a broadcast optical transmission medium which has plural access ports to which the information processing unit and each of the plural storage devices are connected and through which the data is inputted and outputted, and through which the data is transmitted as optical signals.

The information processing unit and each of the plural storage devices may be connected to the access ports of the broadcast optical transmission medium by: direct optical connections; electric connections with light emitting apparatuses and light receiving apparatuses provided in the access points of the broadcast optical transmission medium; or direct optical connections with the information processing unit and one of the plural storage devices and electrical connections with others. Therefore, optical signals may be directly inputted to and outputted from the broadcast optical transmission medium, or optical signals transformed from electric signals may be transmitted to it. The information processing unit may be connected to the broadcast optical transmission medium through, e.g., a controller. That is, the information processing unit and the plural storage devices may be connected so that information to be transmitted is transmitted as optical signals through the broadcast optical transmission medium.

### BRIEF DESCRIPTION OF THE DRAWINGS

Preferred embodiments of the present invention will be described in detail based on the followings, wherein:

FIG. 1 is a block diagram of a system having an array storage device showing a first embodiment of the present invention;

FIG. 2 is a diagram showing a timing chart for data writing of the array storage device of the first embodiment;

FIG. 3 is a block diagram of an array storage device showing a variant of the first embodiment;

FIG. 4 is a block diagram of an array storage device showing a second embodiment; and

FIG. 5 is a diagram showing a timing chart for data writing of a conventional array storage device.

### DESCRIPTION OF THE PREFERRED EMBODIMENTS

Hereinafter, embodiments of the present invention will be described.

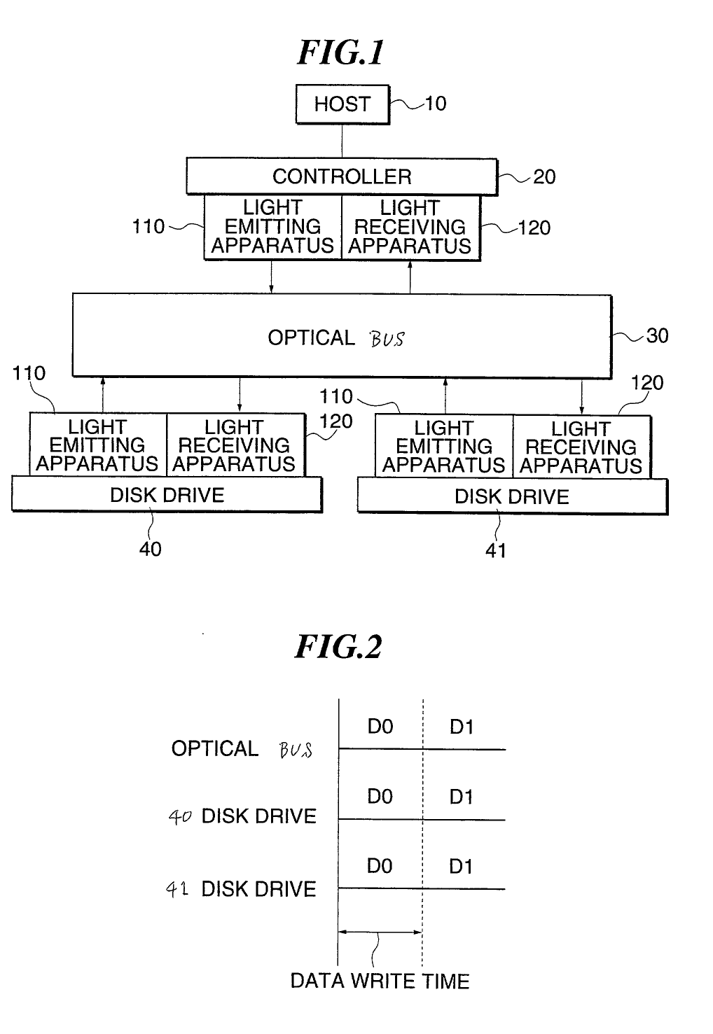

FIG. 1 is a block diagram of a system having an array storage device of a first embodiment of the present invention; RAID1 is configured by one disk array controller and two or plural disk drives. In FIG. 1, reference numeral 10 designates a host; 20, a disk array controller; 30, an optical bus; and 40 and 41, disk drives. The disk array controller 20 and the disk drives 40 and 41 include a light emitting apparatus 110 that transforms an electric signal into an optical signal, and a light receiving apparatus 120 that transforms an optical signal into an electric signal. The disk drives 40 and 41 have a hard disk drive, a magneto-optical (MO) recording apparatus, and a rotational storage device in and from which recording media such as DVD-RAM can be mounted and dismounted, a tape recording apparatus such as DAT, and a nonvolatile storage device such as a semiconductor memory. Each of the light emitting apparatus 110 and the light receiving apparatus 120 is optically connected to an access port of the optical bus 30. For a write request from the host 10, the disk array controller 20 stores write data in a cache memory (not shown), and then transforms it into an optical signal by the light emitting apparatus 110 and sends the optical signal to the optical bus 30.

As the optical bus 30, an optical bus disclosed in, e.g., Japanese Published Unexamined Patent Application No. Hei 10-123350 can be used. The optical bus, which employs a sheet-like optical transmission medium, enables broadcast transmission of inputted signal light into plural ports by the scattering and propagation of it by a light scattering part which is positioned on the light path of the inputted signal light and, for example, provided in an input part or on an opposite surface to the input part.

Since signal light inputted to the optical bus 30 is broadcast-transmitted, the disk drives 40 and 41 can read the signal light simultaneously. The disk drives 40 and 41 transform the sent signal light into an electric signal by the light receiving apparatus 120 to write data.

FIG. 2 shows a timing chart of data writing in the present embodiment. Since data writing to the two disk drives is terminated by only one transmission of data from the disk array controller 20, a writing speed is not reduced by mirroring.

On the other hand, for a data read request from the host 10, the disk array controller 20 returns, if request data exists in the cache memory, the request data to the host 10. When it does not exist in the cache memory, the disk array controller 20 outputs to an optical bus an optical signal containing a data read instruction for one of the disk drives 40 and 41, e.g., the disk drive 40. Data of the disk drive 40 is transformed into an optical signal by the light emitting apparatus 110, transmitted to the light receiving apparatus 120 of the disk array controller 20 via the optical bus 30, and transformed into an electric signal by the light receiving apparatus 120. The disk array controller 20 returns the data to the host 10 and stores it in the cache memory. If a failure occurs in the disk drive 40, data can be read from another disk drive 41 according to the same procedure.

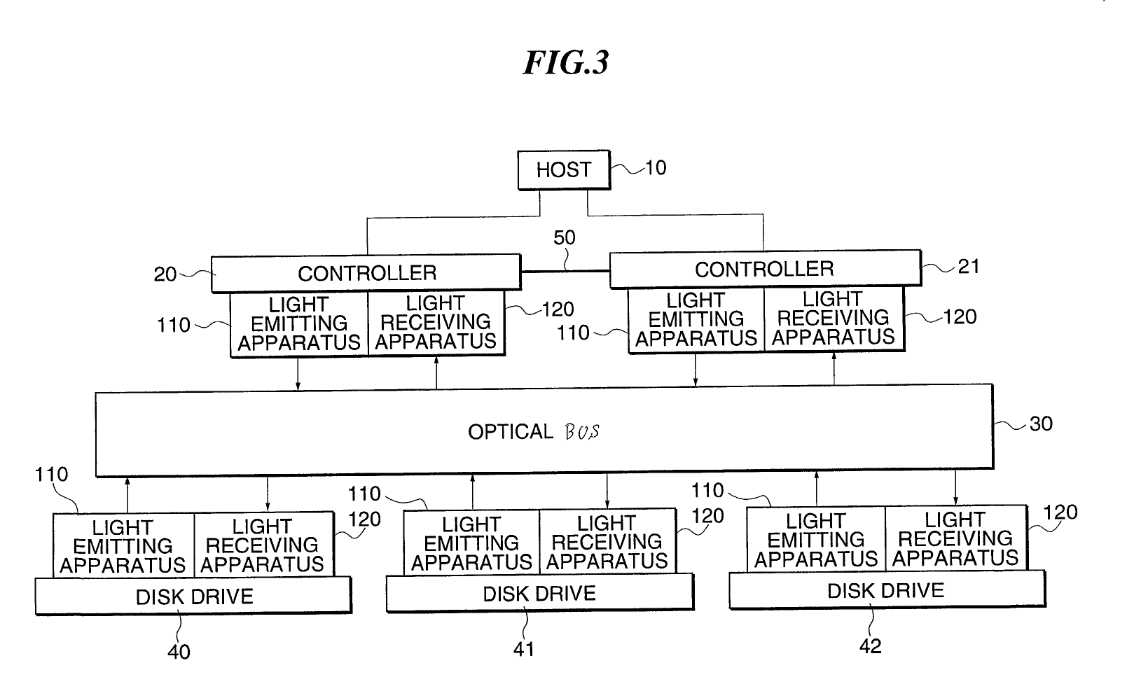

In FIG. 3, a disk array controller 21 and a disk drive 42 are newly added to the array storage device shown in FIG. 1 to increase reliability for a controller failure. The disk array controller 21 and the disk drive 42 are connected to each of other access points of the optical bus 30, and the disk array controllers 20 and 21 are newly connected by a bus cable 50. The two disk array controllers, that is, plural disk array controllers operate through the bus cable 50 so that data of their cache memories become equal (cache mirroring). Upon receipt of a reading or writing indication selectively issued from the host, one of the disk array controllers optically transmits an operation command signal through an access port along with a signal for locating a corresponding disk drive. Upon receiving the optical signal, the specified disk drive performs an indicated operation and receives or outputs data from the access port. If one of the disk array controllers fails, the host changes the disk array controller to operate.

A superior controller to control the plural disk array controllers may be provided to control cache mirroring and the disk controller, in which case the bus cable can be omitted. Although installation of electric wirings between the superior controller and the disk array controllers reduces the capability to add disk controllers, since the existence of two or three disk controllers is often sufficient to have high reliability, this configuration is sufficiently effective when the capability to add disks is primarily required.

By using a broadcast optical transmission medium in this way, all interconnections need not be reconfigured and the system can be easily expanded.

Although, in the present embodiment, a sheet-like optical transmission medium and the light scattering part to scatter and propagate inputted signal light are used for the optical bus 30, the present invention is not limited to this type of optical transmission medium; any broadcast optical transmission medium is permitted which allows an optical signal to be transmitted in parallel from one access port to plural access ports, and furthermore, if the transmission medium is a medium capable of bidirectional transmission of an optical signal between the storage device and the controllers, the system is made more simplified and is increased in expandability. In addition to the scattering and propagation type of this embodiment, an optical star coupler, an optical divider, an optical coupler, for example, may be used in combination.

Although the light emitting apparatus 110 and the light receiving apparatus 120 are provided in the disk array controller 20 and the disk drives 40 and 41 (the disk controller 20 and 21, and disk drives 40, 41, and 42 in FIG. 3), the light emitting apparatus 110 and the light receiving apparatus 120 may be provided in the optical bus 30 so that connection interfaces with the disk array controller 20 and the disk drives 40 and 41 (the disk controller 20 and 21, and disk drives 40, 41, and 42 in FIG. 3) are electric signals. That is, the optical bus of the present invention has the function to broadcast-transmit optical signals and its connection interface may be optical signals, electric signals, or mixtures of them. If the light emitting apparatus and the light receiving apparatus to serve as access points are provided in the optical bus, the disk array controllers and the disk drives are electrically connected to the optical bus.

All or some of the host, optical bus, storage device, or controllers may be configured so as to be separable. In this case, preferably, the controllers and the host are directly connected in terms of transmission speed. If the storage device connected is not provided with a photoelectric conversion part, an electric connection is made with the storage device up to a connector, and after the connector, an apparatus to photoelectrically convert electric signals may be provided. In this case, power for driving the photoelectric conversion apparatus may be supplied from the host through the controllers, or the photoelectric conversion apparatus may be directly connected with a power supply.

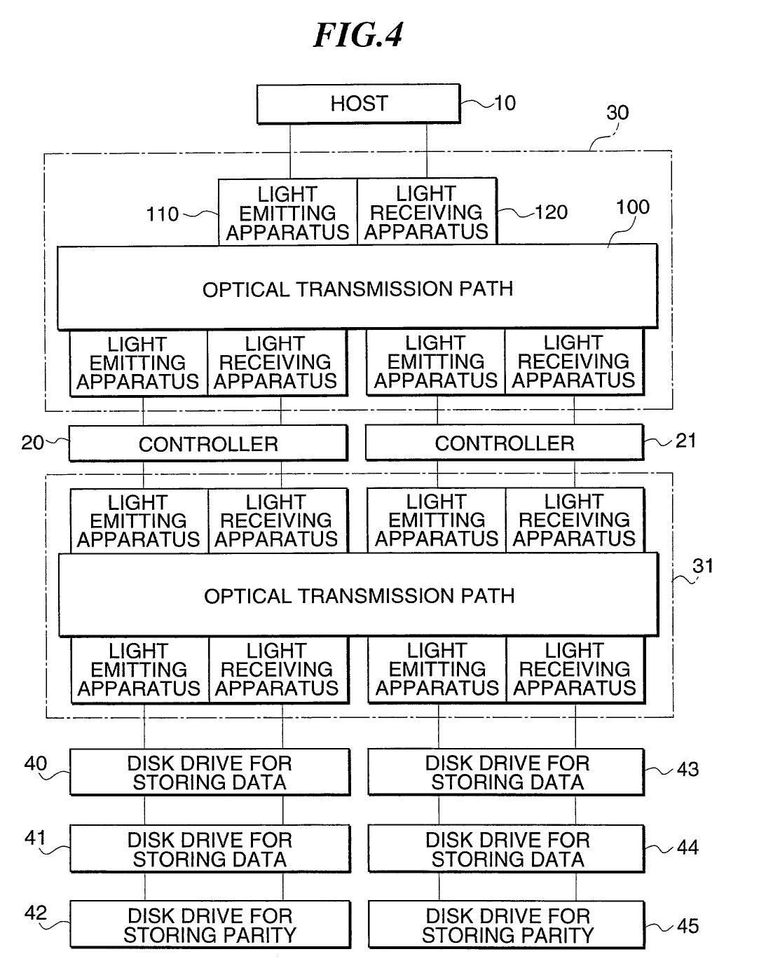

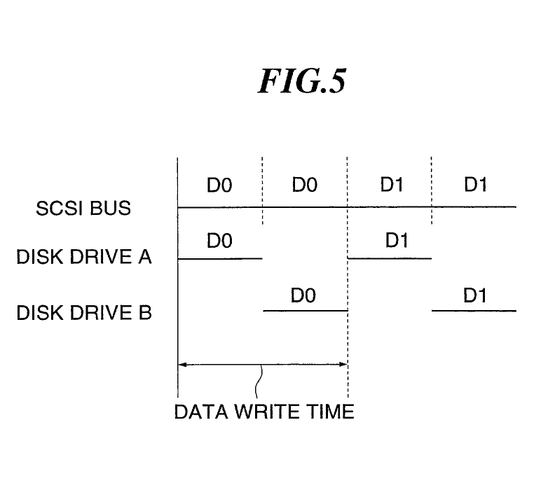

FIG. 4 is a block diagram of an array storage device of a second embodiment of the present invention; RAID1+4 is constituted by two or plural disk array controllers, and six or plural disk drives. In FIG. 4, a reference numeral 10 designates a host; 20 and 21, disk drive controllers; 30 and 31, optical buses; and 40 to 45, disk drives. The optical buses 30 and 31 have an optical transmission path 100, a light emitting apparatus 110, and a light receiving apparatus 120. The disk drives 40, 41, and 42, and the disk drives 43, 44, and 45 constitute RAID4 respectively as one block unit; the disk drives 40, 41, 43, and 44 are used to store data, and the disk drives 42 and 45 are used to store parity data. Mirroring is performed between two or plural blocks. Each block has plural types of disk drives differing in function between data storage and parity storage. Plural disk array controllers and plural disk drive blocks having plural types of disk drives are optically connected to access points of the optical bus 31.

For a write request from the host 10, data from the host 10 is transmitted to the disk array controllers 20 and 21 simultaneously by the optical bus 30. The disk array controllers 20 and 21 store write data in cache memories, respectively. One of the disk array controllers, e.g., the disk array controller 21, subjects the data transferred from the host 10 to striping and parity generation by a striping circuit and a parity generation circuit (both not shown) to send the data and parity data in a time-sharing mode to the optical bus 31. The data and parity data sent from the optical bus 31 are transferred simultaneously to two blocks which perform mirroring. For example, letting the data be D1 and D2, and the parity data be P, the disk array controller 21 first sends the data D1 and writes it to the disk drives 40 and 43 for data storage. Next, the disk array controller 21 sends the data D2 and writes it to the disk drives 41 and 44 for data storage. Finally, the disk array controller 21 sends the parity data P and writes it to the disk drives 42 and 45 for parity storage. Although data writing to the disk drives within each block is performed in a time-sharing mode in this way, since identical data is written simultaneously to the two disk drives, a writing speed will not be reduced by mirroring.

On the other hand, for a data read request from the host 10, one of the disk array controllers 20 and 21 returns, if request data exists in the cache memory, the request data to the host 10. When it does not exist in the cache memory, one of the disk array controllers, e.g., the disk array controller 20 inputs to an optical bus an optical signal containing a read instruction for one of the disk drive blocks, e.g., the disk drives 40, 41, and 42. If no failure occurs in the disk drives 40 and 41 for data storage, request data read from the disk drives 40 and 41 for data storage is sent to the optical bus 31. If read request data resides across the disk drives 40 and 41 for data storage, the data is sent to the optical bus 31 in a time-sharing mode as for a write request. If a failure occurs in one of the disk drives 40 and 41 for data storage, the data and parity data are sent to the optical bus 31 from a failure-free disk drive for data storage and the disk drive 42 for parity storage. The data and parity data sent from the disk drives 40, 41, 42 are sent simultaneously to the disk array controllers 20 and 21 by the optical bus 31. The two disk array controllers 20 and 21 store the data in their respective cache memories if no failure occurs in the disk drives 40 and 41 for data storage, and if a failure occurs in one of the disk drives for data storage, generates data from the data and parity data, stores it in the their respective cache memories, and returns it to the host 10 from one of the disk array controllers.

In a configuration in which plural disk array controllers exist as shown in the present embodiment, cache memory data in the two disk array controllers 20 and 21 must be made equal (cache mirroring). As described above, since the host 10 and the two disk array controllers 20 and 21 are connected by the optical bus 30, write data from the host 10 is transferred simultaneously to the two disk array controllers 20 and 21. Read data from the disk drives is also transferred to the two disk array controllers 20 and 21, since the disk array controllers and the disk drives are connected by the optical bus 31. Therefore, as described above, without providing a bus for connecting the disk array controllers 20 and 21, cache mirroring can be performed. Also, there is the advantage that, by connecting the host 10 with the disk array controllers 20 and 21 by the optical bus 30, a disk array controller can be added without the need to newly establish a connection among disk array controllers by a bus cable.

The present invention is applicable regardless of the above-described RAID method.

Application to a RAID0 system provides expandability, and speedup in comparison with conventional striping which employs electric wirings. That is, in the RAID0 system, since data is written and read to and from plural disk drives in a time-sharing mode, speedup cannot be achieved unless controller I/O, a bus between controllers and disk drives, and disk I/O are higher in data transfer speed in that order. Although conventional electric buses have had a bottleneck in a bus transfer speed between controllers and disks in an attempt to achieve speedup by striping, since the data transfer speed of optical buses is higher than that of controller I/O, speedup (including the transfer speed of controller I/O) by striping is enabled.

With a RAID4 or RAID5 system, independent of mirroring, as in FIG. 4, e.g., usually, the data disk drives 40 and 41, and a disk drive for parity storage are used as one disk block so that addition is made in block units, not in disk drive units. Disk blocks are connected to controllers in parallel because daisy chain connections extremely reduce writing speed. Therefore, in configuring a RAID4/5 system by using electric wirings, unless controllers have plural output ports in advance, addition is impossible, and the number of addable disk drives is fixed at system design unless controller replacement or the like is performed. On the other hand, the use of optical buses (broadcast transmission type) enables addition of disk drives (blocks) within the limit of the number of access ports of an optical bus even if the number of output ports from controllers is one, providing extremely high system expandability.

In addition from one controller to two controllers in a configuration in which plural disk blocks are connected in a RAID4/5 system, although it has been conventionally necessary to reconfigure electric wirings between each disk block and the controllers, the present invention eliminates the need for reconfiguration and provides high system expandability for controller addition.

Although, in the above-described embodiment, access to each disk block from a controller is made in a time-sharing mode, since the data transfer speed of an optical bus is sufficiently higher than those of disk blocks and controller I/O, almost the same data transfer speed as in conventional parallel connections by an electric bus can be obtained. The use of multiplexing techniques such as wavelength multiplexing and intensity multiplexing allows access to be made simultaneously to plural different disk blocks, enabling parallel operations and contributing to an increase in data transfer speed.

As has been described above, the present invention provides the advantage that reduction in data writing speed in mirroring can be suppressed and an array storage device and an information processing system having high expandability can be obtained.

The entire disclosure of Japanese Patent Application No. 2000-074807 filed on Mar. 16, 2000 including specification, claims, drawings and abstract is incorporated herein by reference in its entirety.

What is claimed is:

1. An array storage device in which information inputted to and outputted from an information processing unit is stored, the array storage device comprising:
plural storage devices storing the information; and
a broadcast optical transmission medium which has plural access ports to which the information processing unit and each of the plural storage devices are connected and through which the information is inputted and outputted, and through which the information is transmitted as optical signals.

2. The array storage device according to claim 1, further comprising a controller, connected to at least one of the access ports, which outputs signals for controlling data input-output operations of the plural storage devices to the broadcast optical transmission medium through the access ports other than the above at least one for transmission to the plural storage devices.

3. The array storage device according to claim 2, wherein the controller outputs the signals so that the plural storage devices operate as a RAID system.

4. An information processing system, comprising:
an information processing unit that inputs and outputs data;
plural storage devices storing the data; and
a broadcast optical transmission medium which has plural access ports to which the information processing unit and each of the plural storage devices are connected and through which the data is inputted and outputted, and through which the data is transmitted as optical signals.
